(19) United States
(12) Patent Application Publication
(10) Pub. No.: US 2014/0360176 A1
(43) Pub. Date: Dec. 11, 2014

(54) WAVE-POWERED ELECTRICITY GENERATOR

(71) Applicant: DIEN-FOON WU, Taipei (TW)

(72) Inventor: DIEN-FOON WU, Taipei (TW)

(21) Appl. No.: 14/297,647

(22) Filed: Jun. 6, 2014

(30) Foreign Application Priority Data
Jun. 6, 2013 (TW) 102210631

(51) Int. Cl. F03B 13/16

(52) U.S. Cl. CPC F03B 13/16
USPC 60/505

(57) ABSTRACT

This invention is a wave powered electricity-generating mechanism which utilizes the fluctuations of multiple pontoons and ratchets' direction control to integrate various gear speeds into a high speed in order to drive an electricity generator. There are low, medium, and high speed gear sets. Low speed is for a quick start, higher speeds are to adopt lower speeds. The highest speed can be calculated in advance by adjusting the number of dynamic units, gear ratios, and number of transmission phases of gear sets in order to keep a designated output speed. This mechanism does not need to be fastened to the coast. Due to the independence feature of each dynamic unit, the number of dynamic units can be adjusted to meet various power output requirements.

### FIELD OF THE INVENTION

The present invention is related to an electricity generator, especially for a wave powered electricity-generating mechanism that converts wave energy into gear spinning motion for generating electricity.

### BACKGROUND

In the world, there are thousands of facilities using wave undulation power to generate electricity in the following models: 1. Suspension pendulor, 2. Floating pendulor, 3. Oscillation water pillar, 4. Transcending wave, 5. Duck, 6. Raft, 7. Point absorption, and 8. Magnetic fluid wave energy. All of them are tremendous engineering works. Generally speaking, they are expensive, difficult to maintain, low-efficiency and unstable.

### SOME EXEMPLARY EMBODIMENTS

According to the above drawback of the conventional prior art, an approach of the present invention provides a wave-powered electricity generator that comprises a basic frame which is equipped with at least two sets of dynamic unit for carrying two pontoons driven up and down by wave power to drive power axis in a single direction. The wave-powered electricity generator further comprises a backbone frame which is connected to the basic frame. The backbone frame comprises electricity generating gear sets which are connected to the corresponding power axis in the basic frame. The electricity generating gear sets consolidate spinning powers to drive an electricity generator to generate electricity.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is perspective view of a dynamic unit in accordance with an embodiment of the present invention;

FIG. 2 is a perspective view of a basic frame in accordance with an embodiment of the present invention;

FIG. 3 is a perspective view of a backbone frame in accordance with an embodiment of the present invention;

FIG. 4 illustrating a top of the integration of the basic frame and the backbone frame in accordance with an embodiment of the present invention ;

FIG. 5 is a perspective view of direct-integration of the basic frame and the backbone frame in accordance with another embodiment of the present invention;

FIG. 6 is a perspective view for illustrating power transmission from basic frame to backbone frame with gears;

FIG. 7 is a perspective view for illustrating power transmission from basic frame to backbone frame with chains;

FIG. 8 is a perspective view for illustrating the position of backbone frame;

FIG. 9 is a perspective view for illustrating the connection of backbone frame and basic frame with chain and electricity-generating gear sets;

FIG. 10 illustrates a wave-powered electricity generator in accordance with an embodiment of the present invention;

FIG. 11 is a perspective view for illustrating power transmission from basic frame to backbone frame with chains and set up several different sized gears;

FIG. 12 is a perspective view for illustrating the backbone frame where the Low-speed area has been omitted;

FIG. 13 is an another perspective view for illustrating the backbone frame in accordance with an embodiment of the present invention;

FIG. 14 is a perspective view for illustrating the connection of backbone frame and basic frame with chain in accordance with an embodiment of the present invention;

FIG. 15 illustrates an embodiment for preventing the wave-powered electricity generator from drifting away; and

FIG. 16 illustrates that the distance between two pontoons of a dynamic unit corresponds to half of the wave length.

### DESCRIPTION OF THE PREFERRED EMBODIMENT.

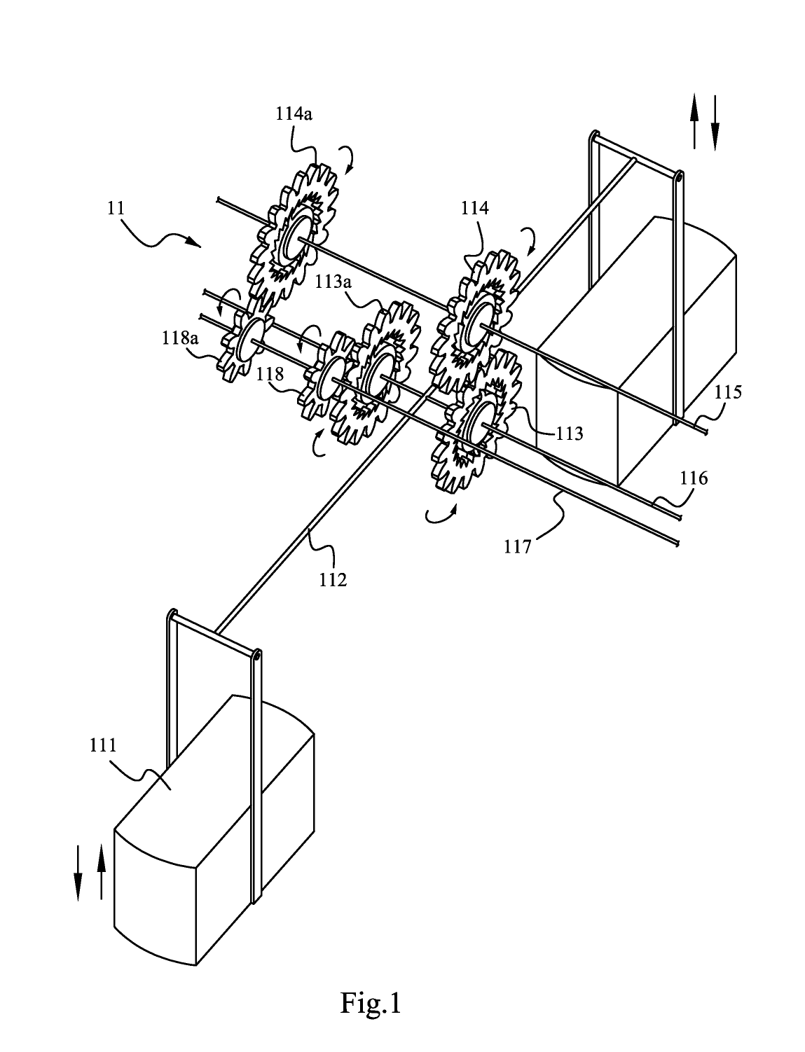

With reference to FIGS. 1-3, the wave-powered electricity generator comprises a dynamic unit 11, a basic frame 1 and a backbone frame 2.

In FIG. 1, the structure of the dynamic unit 11 is illustrated, which comprises two pontoons 111, a connecting axis 112, two dynamic gears 113, 113a, two power gears 114, 114a, power axis 115 and two indirect gears 118, 118a. Two pontoons 111 connected to the connecting axis 112 are being forced up and down by wave undulation. These two pontoons 111 go in opposite directions to drive the dynamic gears 113, 113a connected to the same axis 116. These two dynamic gears 113, 113a spin in reverse directions which are regulated by two ratchets. By applying the indirect gears 118, 118a connected to a same axis 117, to reverse the spinning direction of the dynamic gear 113a. As a result, two power gears 114, 114a go in the same direction to drive power axis 115.

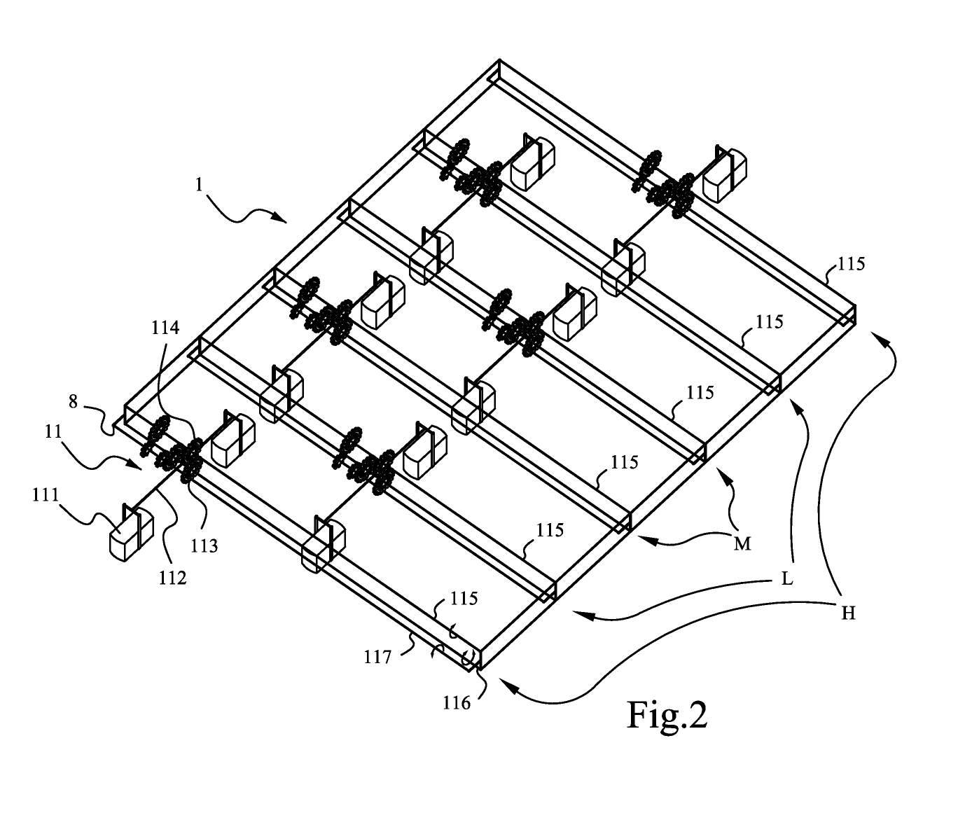

FIG. 2 illustrates the basic frame structure and how pontoons 111 drive power axis 115.

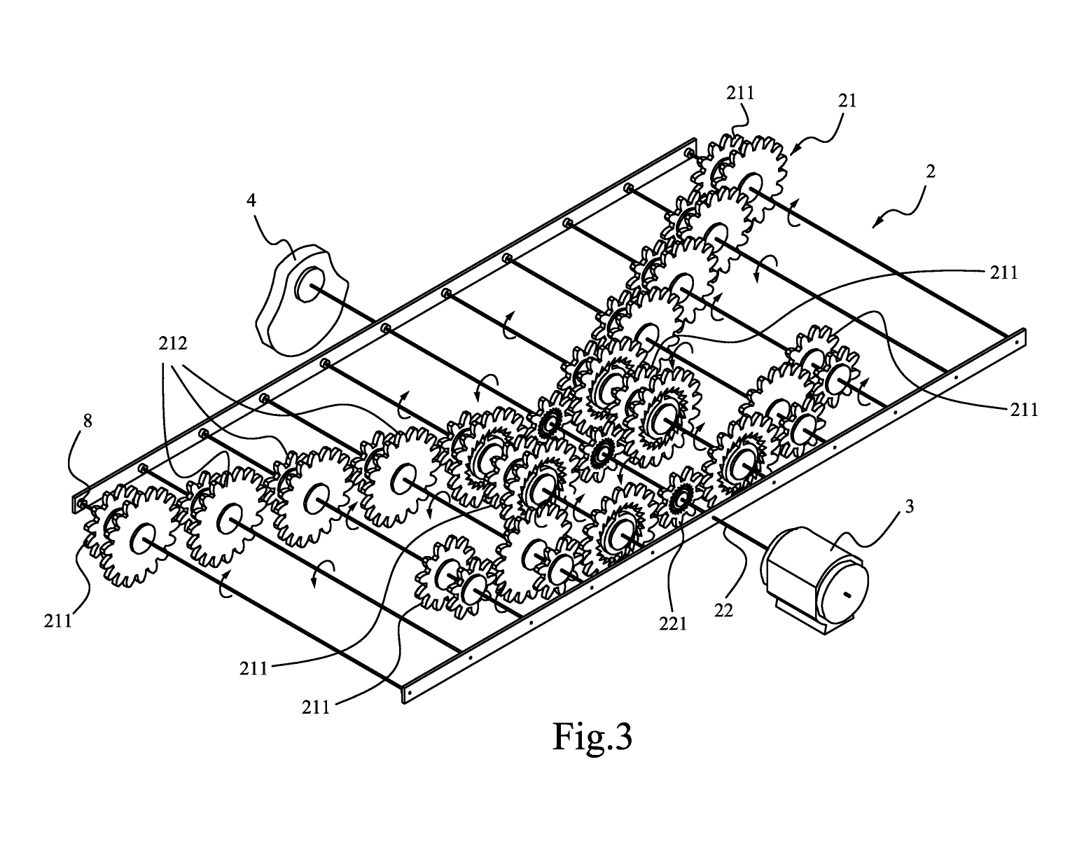

As shown in FIG. 3, the backbone frame 2 is equipped with electricity-generating gear sets 21 which are connected to the output axis 22 to drive electricity generator 3. On the other end of output axis 22, there is equipped with a flywheel 4 to store the kinetic energy of gear sets and to stabilize the spinning motion of the electricity generator 3.

Each axis of electricity-generating gear sets 21 as well as output axis 22, as shown in FIG. 3, may carry bearings at the points to where the side bars of backbone frame 2 are connected in order to mitigate the friction forces.

Pontoons 111 not only provide driving forces onto axis 112 but also support whole mechanism's weight including that of basic frame 1 and backbone frame 2 and all equipment attached to them. This feature makes this mechanism not necessary to be fastened to coast and hence facilitate the installation.

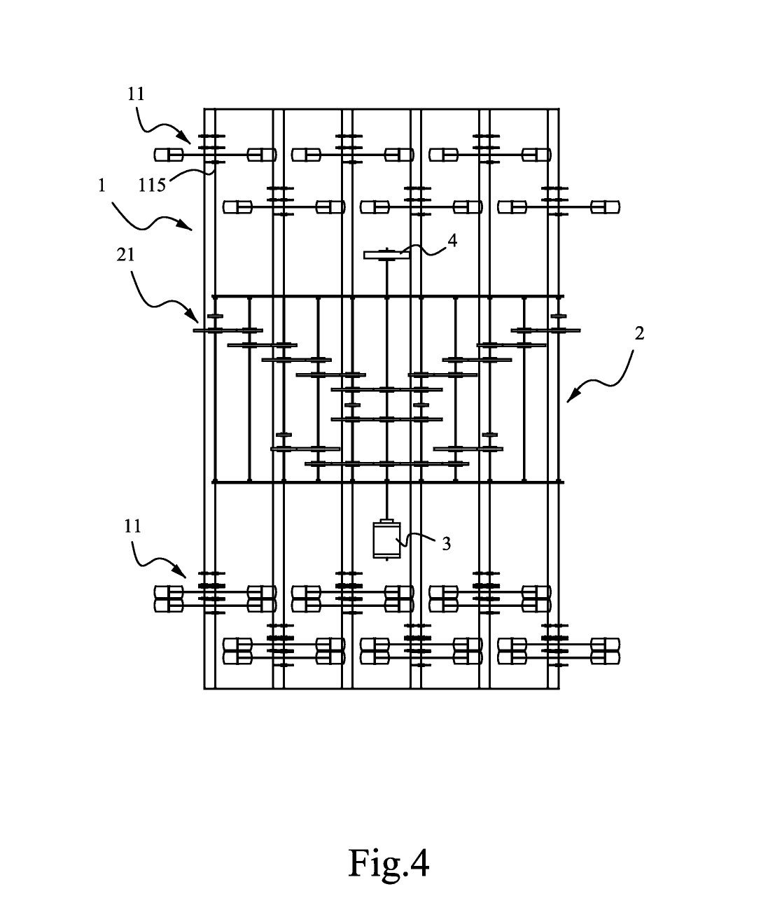

As FIG. 3 and FIG. 4 illustrates, dynamic units 11 are paired. Each electricity-generating gear set 21 is equipped with an active gear 211 which is set on a connecting axis and linked to a corresponding power axis 115. Through collaboration of all electricity-generating gear sets 21, it gives the output axis 22 a high-speed and single-direction spinning power to drive the electricity generator 3.

As FIG. 2 through 4 illustrates, each electricity-generating gear set 21 are consisted of linked passive gears 212 which are configured to drive the output gear 221. Due to the requirements of driving the electricity generator 3, the electricity-generating gear sets 21 are distributed in three areas: Low-speed area (L), Medium-speed area (M), and High-speed area (H). However, it may be designed to have more categorized areas depending on coast topography and wave's undulation degree. More categorized areas may make the speed transition from low to high more smoothly.

The Low-speed area (L): it comprises low-speed gear sets; small gears transmit forces to big gears to produce a low-speed but high-torque force to start the electricity generator through an output gear 221.

The Medium-speed area (M): it comprises medium-speed gear sets to adopt the spinning forces transmitted from Low-speed area (L) to drive an output gear 221.

The High-speed area (H): it comprises high-speed gear sets; big gears transmit forces to small gears; to adopt the spinning forces transmitted from Medium-speed area (M) to drive an output gear 221 with a predictable high speed.

Each of the output gears 221 in Low, Medium, High areas carries a ratchet to allow output axis' 22 spinning speed exceeds its; At the very beginning stage, the passive gears 212 in High/Medium-speed area cannot drive the output axis 22 in any speed due to their weaker torque force while the passive gears 212 in Low-speed area are doing the job. At this time, the ratchets prevent those passive gears 212 in High/Medium-speed area from blocking output axis's 22 spin. Gradually when the output gear 212 in Medium-speed area gains speed to drive the output axis 22, the ratchet carried in output gear 212 of Low-speed area prevent output axis 22 from being blocked by the low-speed Similarly, the ratchet carried in Medium-speed area, or occasionally in High-speed area, performs the same function when its speed is surpassed by output axis 22.

The high speed used to drive the electricity generator can be calculated in advance by using the following formula:

S2=Rⁿ×S1, wherein S1 is the spinning speed of active gear 211 in High-speed area (H); S2 is the spinning speed of the output axis 22, i.e. the spinning speed of the electricity generator; and R=gear ratio; Can be adjusted according to the actual requirement.

In High-speed area, big gears transmit force to small gears, assuming big gear size and small gear size are constants. If size-wise, the big gear triples the small gear, then R=3.

n=number of phases in a series of gear transmission; can be adjusted according to the actual requirement. Ex. if number of phase=5: i.e.

Big gear A drives small gear a; big gear B drives small gear b (big gear B is coaxial with small gear a); big gear C drives small gear c (big gear C is coaxial with small gear b); big gear D drives small gear d (big gear D is coaxial with small gear c); and big gear E drives small gear e (big gear E is coaxial with small gear d).

Accordingly, the speed of active gear 211 can be calculated from the speed of power axis 115; The speed of the dynamic axis can be estimated from the average speed of power gears 114, 114a which is corresponding to the average speed of wave undulation; Assuming the average speed of the wave undulation is close to a constant in a specific sea area then the speed of active gear 211 (S1) is close to a constant, say 60 rpm, therefore the output speed (S2) is 3⁵=14580 rpm.

The number of dynamic units 11 can be increased depending on undulation degree, spinning speed requirement, and coast topography for increasing the driving force without increasing the electricity generator's speed.

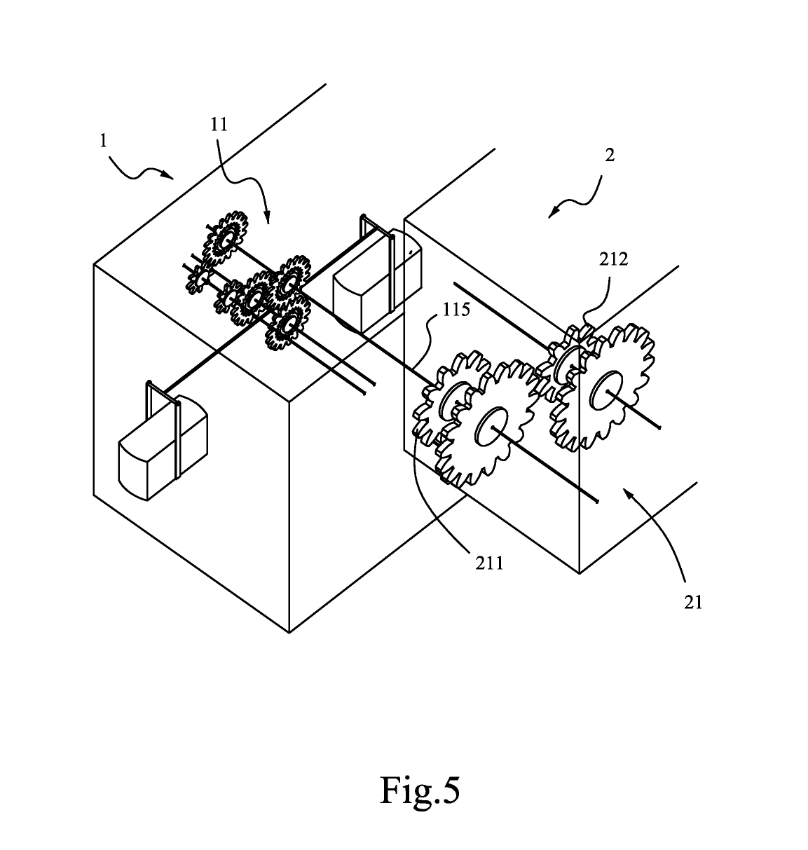

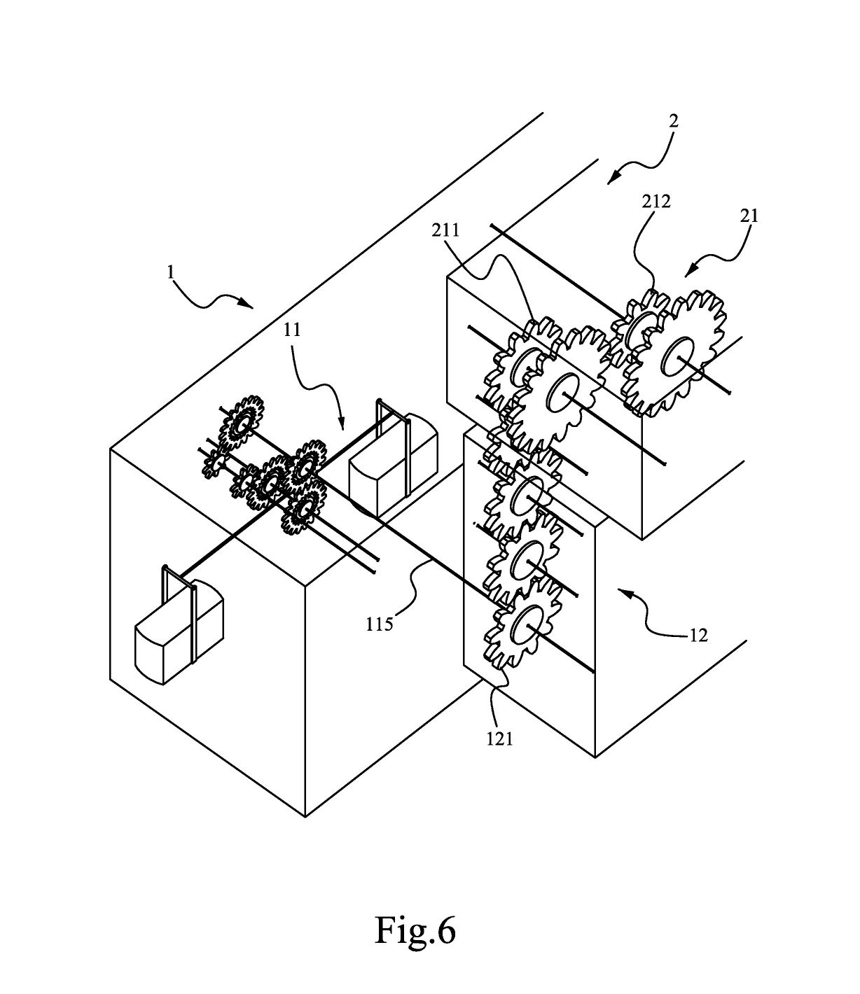

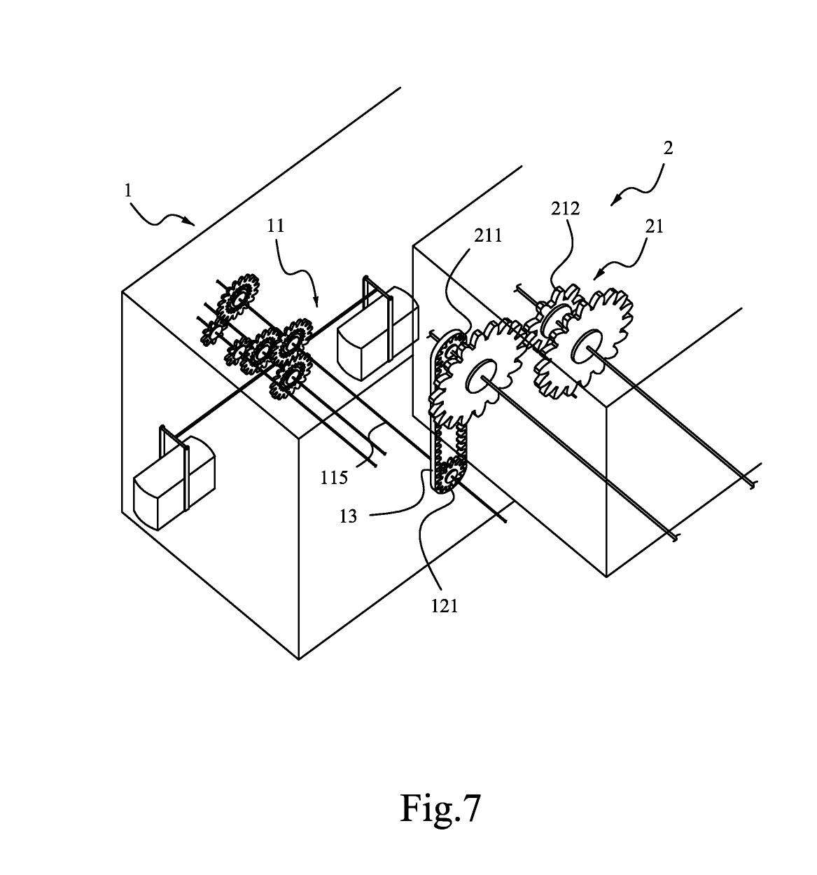

The power axis 115, as shown in FIG. 5, may transmit force to active gear 211 directly by setting active gear 211 on axis 115. However this way of transmission may take more space than that of what FIG. 6 and FIG. 7 illustrated.

FIG. 6 illustrates how power axis 115 transmits force to active gear 211 through intermediate gears in order to lift up the active gear 211 to backbone frame's 2 altitude so that some space on the basic frame 1 may be left for more dynamic unit's 11 installation.

FIG. 7 illustrates how power axis 115 transmits force to active gear 211 through a chain in order to lift up the active gear 211 to backbone frame's 2 altitude so that some space on the basic frame 1 may be left for more dynamic unit's 11 installation.

Therefore, as shown in FIGS. 5 through 7. The active gears 211 may also carry ratchets to prevent two opposite gear sets in the same speed area from blocking each other due to their minor speed difference.

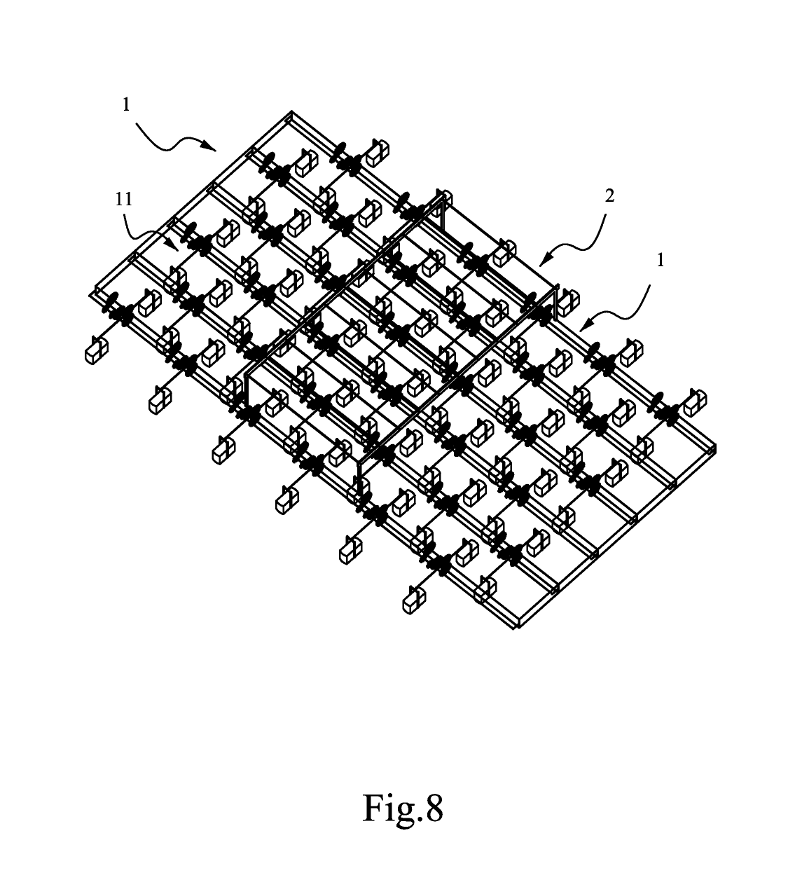

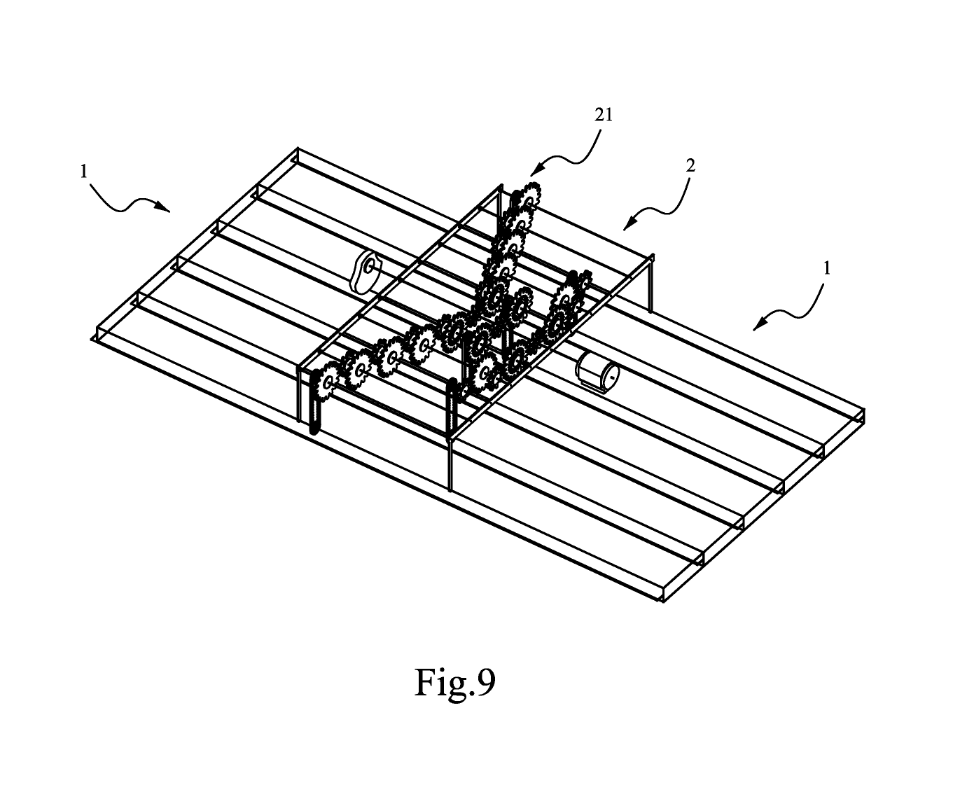

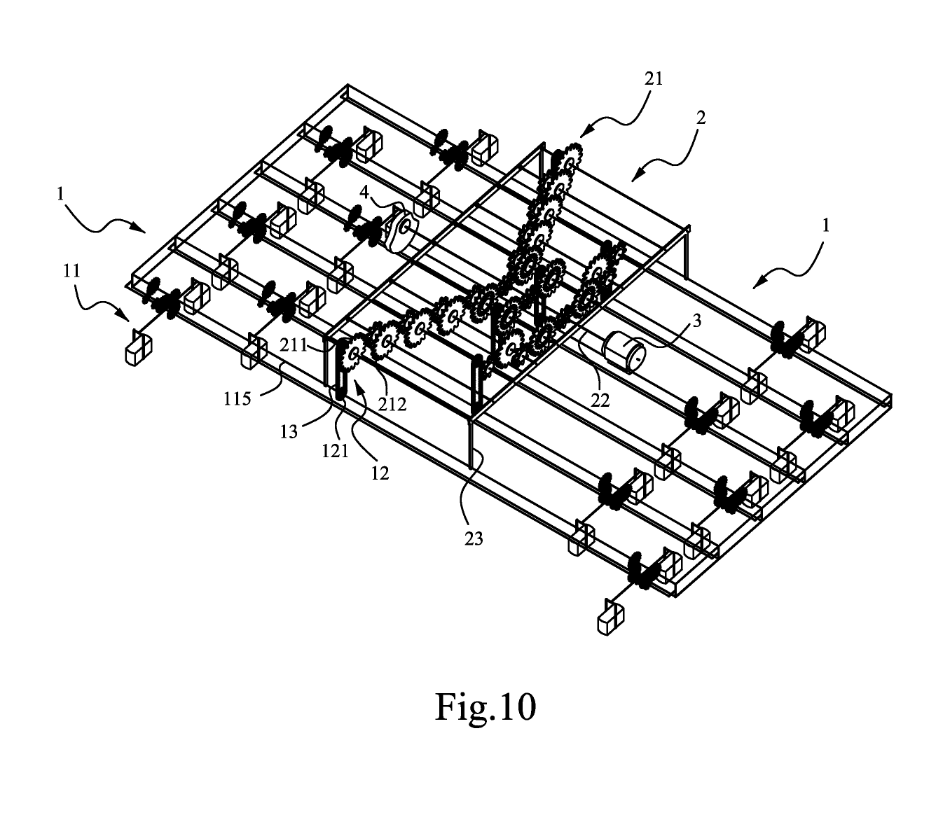

FIG. 8 through FIG. 10 illustrate the implementation of using chain 13 to connect power axis 115 and active gear 211. In FIG. 10, the backbone frame 2 adheres to basic frame 1 with supporting rods 23. FIG. 10 shows only part of dynamic units 11 for clarity sake.

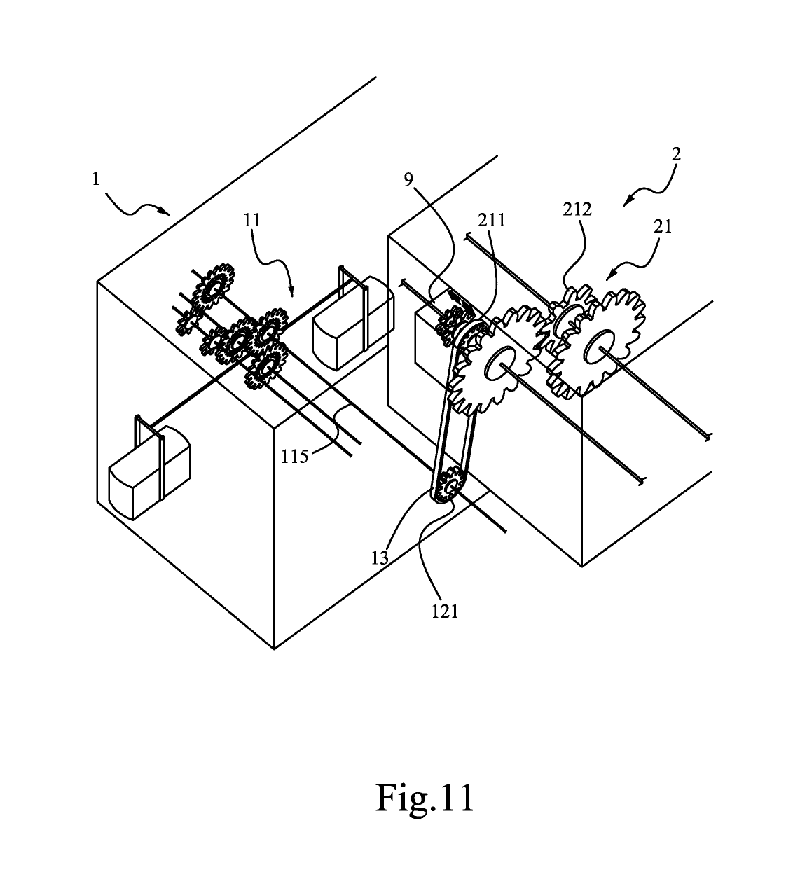

FIG. 11 illustrate the present invention further has several active gears 211 and a derailleur 9, the active gears 211 are in different sizes and arranged on every connecting axis in incremental or decremental order. The derailleur 9 is used to change the spinning speed of the output axis 22. Since the wave undulation power may vary at certain period or area. The spinning speed of the output axis 22 may also varies. The derailleur 9 can be manipulated by pulling the end of the chain 13 for shifting the chain 13 to connecting to a proper sized active gear 211 in order to keep the spinning speed of the output axis 22 a constant.

Further, the speed of the output axis 22 can be changed by coupling different sized gears implemented in the basic frame 1, the gear transmission structure can also be simplified in the backbone frame 2.

Furthermore, the present invention may further comprise a constant speed control device (not figure-illustrated). In this embodiment, a control unit connects to a speed sensor and a brake respectively. Wherein a signal indicating the current speed of the output axis 22 is constantly send to the control unit by the speed sensor. When the speed of the output axis 22 exceeds the designated speed, the control unit immediately activate the brake to lower the speed until it reaches the designated speed, and when the speed slows down to the designated speed, the control unit immediately release the brake to prevent the further slowing down. Therefore this invention keeps the output speed a constant.

Furthermore, the control unit of the constant speed control device also connects to the derailleur 9, thus, the derailleur 9 may be manually or automatically operated, so that, if the output speed in a test running is too high/low, the derailleur 9 can manually or automatically adjusted to keep the output axis 22 at the designated speed.

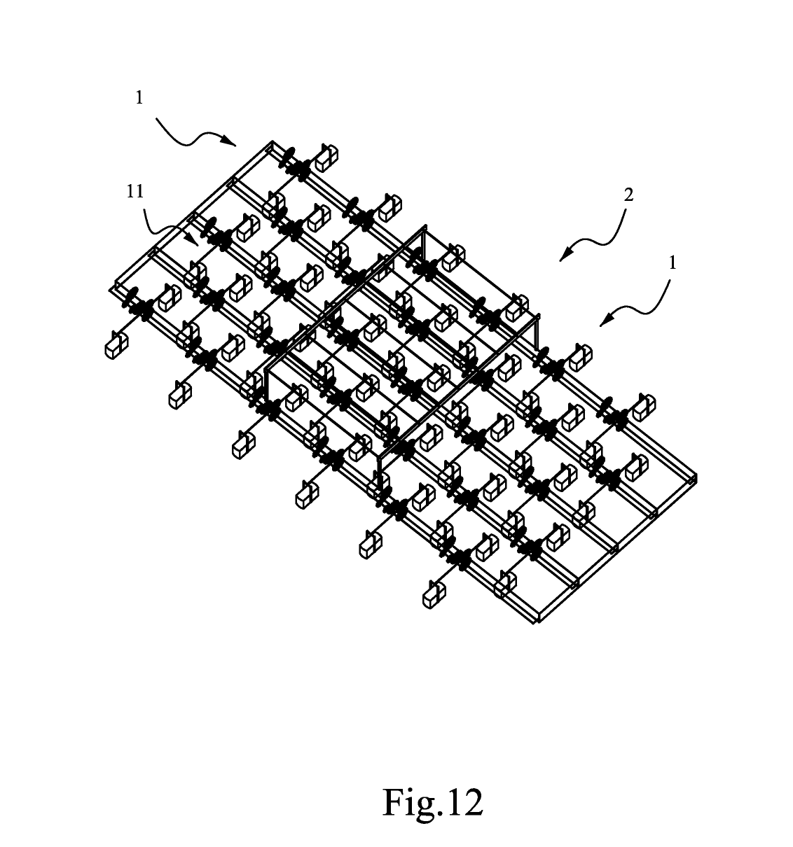

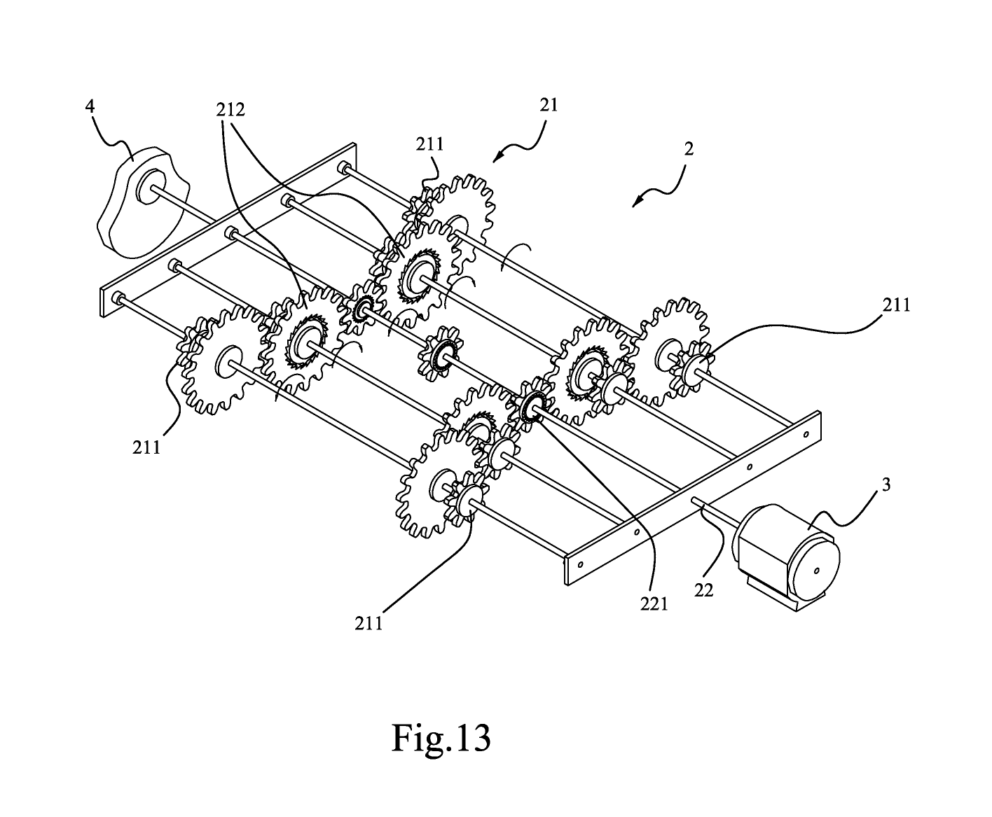

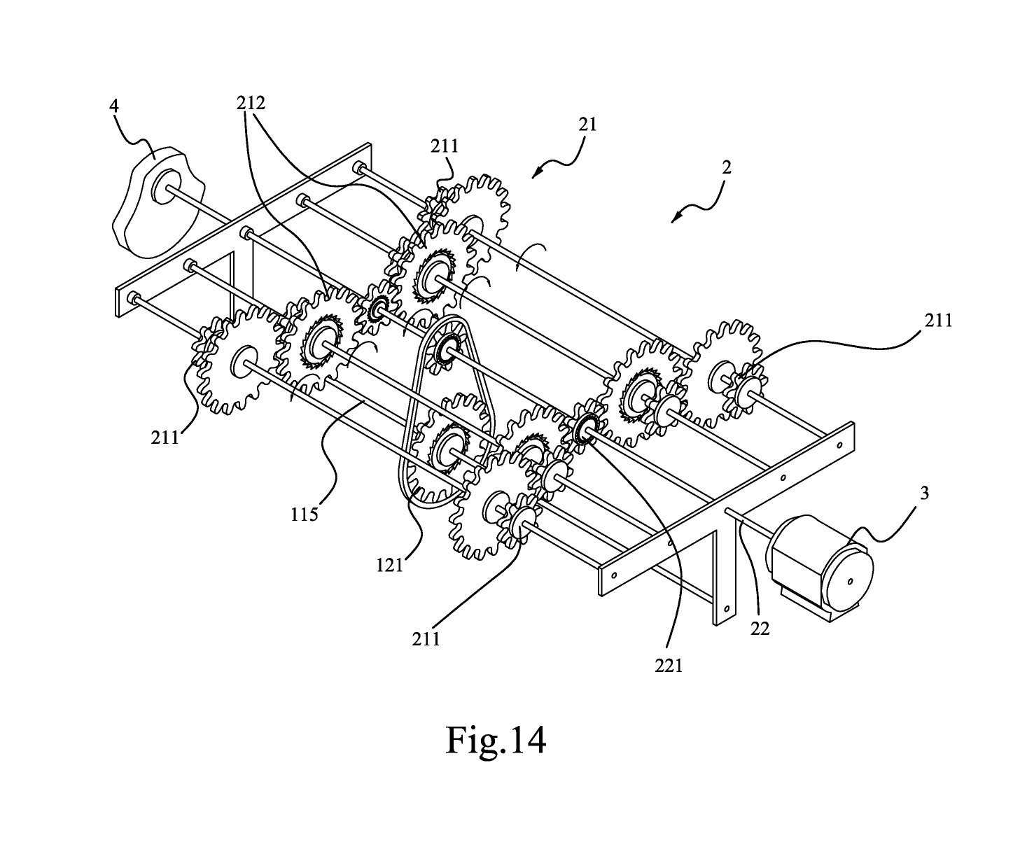

FIG. 12 through FIG. 14 illustrate another implementation of the basic frame 1 and the backbone frame 2, and using the chain 13 to connect the basic frame 1 and the backbone frame 2. In this embodiment, the Low-speed area (L) has been omitted, and several electricity-generating gear set 21 in the backbone frame 2 has also been omitted to simplify the overall structure of the backbone frame 2.

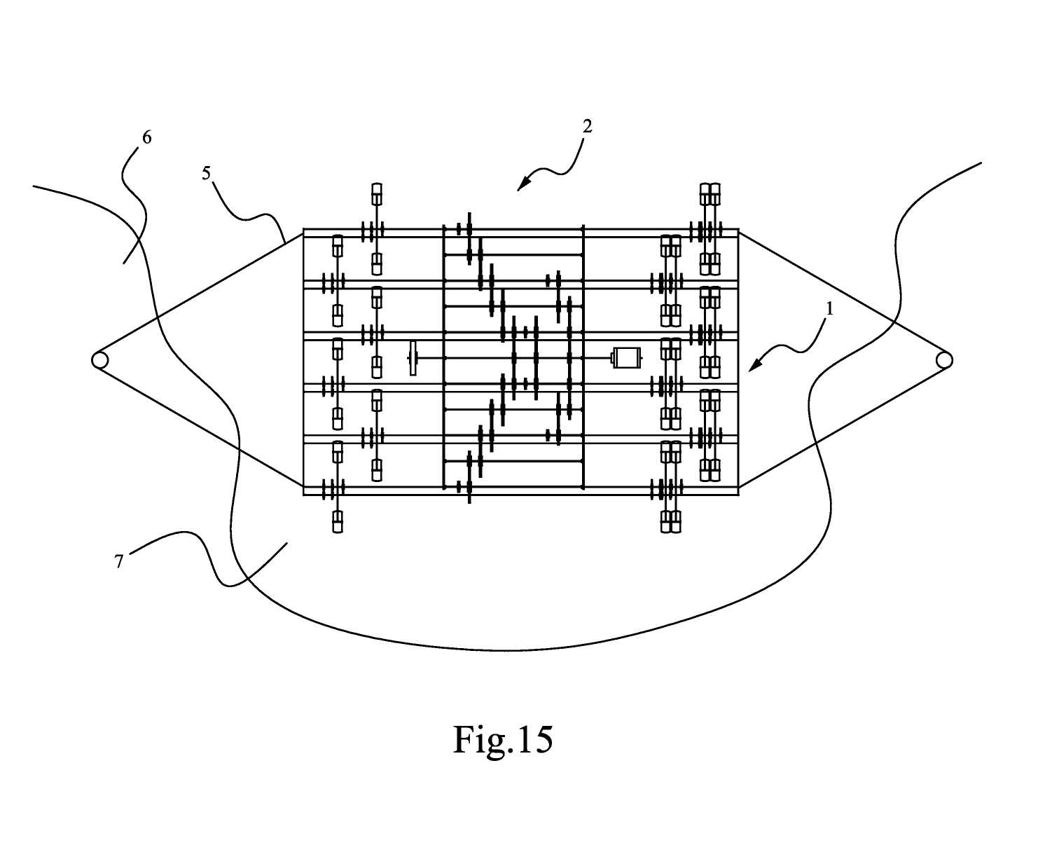

FIG. 15 illustrates using ropes to bind a system for preventing the wave-powered electricity generator of the embodiment of the present invention from drifting away. In this embodiment, it simulates using ropes to bind large ships when they anchor at harbors.

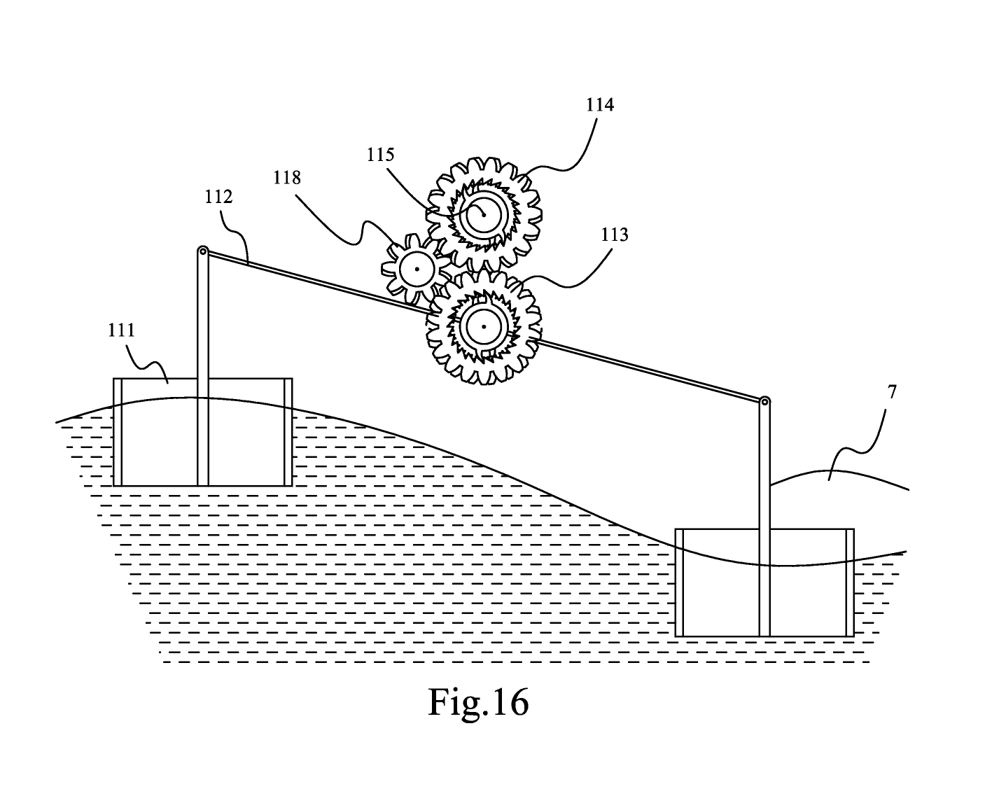

FIG. 16 illustrates that except pontoons, all other facilities can be well lifted up above sea level to prevent their direct contact with seawater, i.e. to prevent them from direct seawater corrosion. It also shows the optimum distance between two pontoons is about half of the wave length. The distance between a pontoon 111 and the connection rod 112 should be well adjusted to prevent their touching each other when pontoon moves.

While the disclosure has been described in connection with a number of embodiments and implementations, the disclosure is not so limited but covers various obvious modifications and equivalent arrangements, which fall within the purview of the appended claims Although features of the disclosure are expressed in certain combinations among the claims, it is contemplated that these features can be arranged in any combination and order.

What is claimed is:

1. A wave-powered electricity generator, comprising a basic frame being equipped with at least two sets of dynamic unit that is carrying two pontoons driven up and down by wave power to drive a power axis in a single direction; a backbone frame being connected to the basic frame and comprising an electricity-generating gear sets which are connected to the corresponding power axis in the basic frame, wherein the electricity-generating gear sets consolidate spinning powers to drive an electricity generator to generate electricity.

2. The generator as claimed in claim 1, wherein the two pontoons are connected to the two ends of a connection rod which carries two power ratchets spinning in opposite directions due to ratchet regulation, wherein one of these two power ratchets is connected to two coaxial indirect gears so that the spin of the power ratchet is direction-reversed, consequently, these two power ratchets' dynamic is transmitted to the power axis in the same direction.

3. The generator as claimed in claim 1, wherein the dynamic units are duplicated in number, and has an active gear and a dynamic axis which are one to one correspondent, wherein each active gear connects to the corresponding electricity-generating gear set for consolidating a spinning force into low, medium, or high speed spin which is depending on the gear-ratio combination, to drive an output axis and finally to drive an electricity generator to generate electricity.

4. The generator as claimed in claim 3, wherein each electricity-generating gear set which is consisted of a passive gears corresponding to one active gear, and the output axis is equipped with output gears which are connected to the passive gears of the electricity-generating gear sets.

5. The generator as claimed in claim 1, wherein the power axis connects to the electricity-generating gear set with a chain or a transmitting gear set for driving force transmission.

6. The generator as claimed in claim 5, wherein the transmitting gear set comprises multiple transmitting gears, and the number and size of the transmitting gears are adjusted to the specification and the spinning direction of the active gear.

7. The generator as claimed in claim 5, wherein the height of the backbone frame is adjustable for avoiding a direct contact between the electricity-generating gear sets of the backbone frame, and the power gears and the power axis of the basic frame.

8. The generator as claimed in claim 5, further comprises a derailleur, and further has at least two active gears on every connecting axis, the active gears are in different sizes and arranged in incremental or decremental order, the derailleur is used to pull the chain and let the power axis connect to a certain sized active gear, so that the speed of output axis can be properly adjusted.

9. The generator as claimed in claim 8, further comprises a constant speed control device which comprises a control unit, a brake and a speed sensor. When the control unit acknowledges the speed of the output axis has exceeded a designated speed, it will activate the brake to reduce the speed of the output axis until the speed slows down to the designated speed and then the brake is released.

10. The generator as claimed in claim 9, the control unit of the constant speed control device also connects to the derailleur, the derailleur may be manually or automatically operated, and the speed of the output axis can be adjusted.
